(19) United States
(12) Patent Application Publication
(10) Pub. No.: US 2016/0295979 A1
(43) Pub. Date: Oct. 13, 2016

(54) SYSTEM FOR MEDICATION TRANSPORT WITH A TRAVELING CASE

(71) Applicants: Sharon Vincent, Racine, WI (US); John Audenby, Hazel Green, WI (US)

(72) Inventors: Sharon Vincent, Racine, WI (US); John Audenby, Hazel Green, WI (US)

(21) Appl. No.: 14/680,386

(22) Filed: Apr. 7, 2015

(51) Int. Cl. A45C 11/00; A45C 13/26; A45C 13/02; A61J 1/00; A45C 5/14

(52) U.S. Cl. CPC A45C 11/00; A61J 1/00; A45C 5/14; A45C 13/02; A45C 13/262; A45C 2011/007; A45C 2013/267

(57) ABSTRACT

A system for medication transport that includes: a storage case; a main compartment within the storage case; a top closure, where the top closure seals the main compartment; a plurality of pockets on an inner surface of the top closure; a pocket on at least one side of the main compartment; and a handle on one side of the main compartment. The system for medication transport may further include wheels on the storage case and the handle may be retractable.

### BACKGROUND OF THE INVENTION

1. Field of Invention

The present invention relates to a medication case for traveling purposes.

2. Description of Related Art

Many times individuals must transport medications while traveling. Some of these medications depending on the conditions of the patient require a substantial amount of room and may be delicate in transporting. For example, Many times diabetics must take multiple needles and other essentials while traveling. As a consequence, it would be advantageous to have a carrying case system that is capable of storing the medication in an orderly manner and providing essential documentation should a medical emergency arise.

### SUMMARY OF THE INVENTION

The present invention relates to a system for medication transport that includes: a storage case; a main compartment within the storage case; a top closure, where the top closure seals the main compartment; a plurality of pockets on an inner surface of the top closure; a pocket on at least one side of the main compartment; and a handle on one side of the main compartment. The system for medication transport may further include wheels on the storage case and the handle may be retractable.

### BRIEF DESCRIPTION OF DRAWINGS

FIG. 1 provides a perspective view of a traveling medication case in accordance with the present invention.

### DETAILED DESCRIPTION

The present invention relates to a system for traveling with medication that includes a unique medication case for storage and transport of essential medication. The present invention includes a case that includes wheels, a retractable handle and several pockets for storing medication as needed. The case also includes an opening within the main portion to store bottles, vials or other medication as necessary.

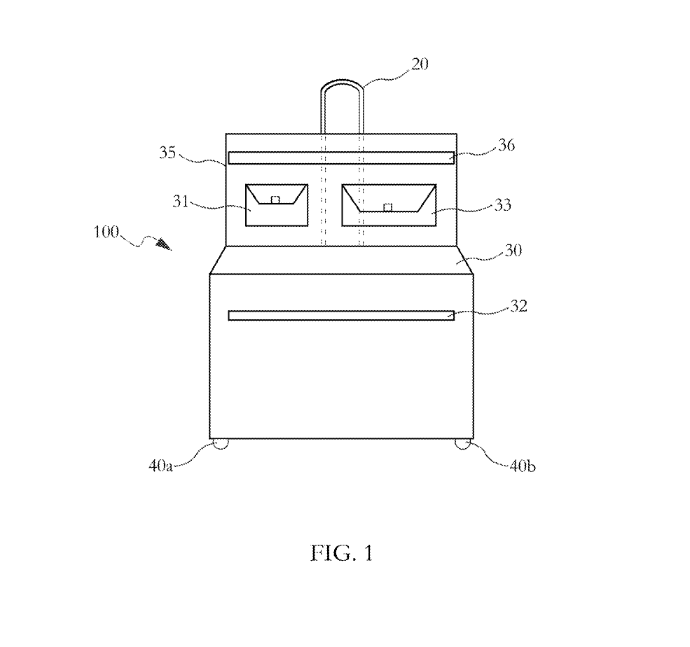

With respect to FIG. 1, a traveling medication case 100 is depicted. This medication case 100 includes a storage area 30 that is normally sealed, however shown in an open position. A top closure 35 provided folds over and may be zipped closed during transport. The top closure 35 includes a sleeve pocket 36 for storage of any necessary documentation as related to the medication within the case. Pockets 31, 33 are also provided on the inside surface of the top closure 35 and therefore are exposed when the top closure 35 is lifted open. The pockets 31, 33 may be used for specific medical supplies such as diabetic needles and related diabetic supplies. The medication case 100 also includes a side pocket 32 on one side of the case as shown in FIG. 1. Wheels 40a, 40b are provided to support the case and enable a means for the user to easily roll the case while traveling.

The medication case according to present invention provides a complete system for transporting multiple medications that may be needed by a user. Further these medications may therefore stored in one case making it easier for the user to locate and maintain the medication while traveling. The instant invention has been shown and described in what it considers to be the most practical and preferred embodiments. It is recognized, however, that departures may be made there from within the scope of the invention and that obvious modifications will occur to a person skilled in the art.

1. A system for medication transport comprising:
a. a storage case;
b. a main compartment within the storage case;
c. a top closure, where the top closure seals the main compartment;
d. a sleeve pocket an inner surface of the top closure;
e. a first pocket on the inner surface of the top closure;
f. a second pocket on the inner surface of the top closure, where the first pocket and second pocket are below the sleeve pocket;
g. a pocket on at least one side of the main compartment; and
h. a handle on one side of the main compartment.

2. The system for medication transport according to claim 1, where further including wheels on the storage case.

3. The system for medication transport according to claim 1, where the handle is retractable.
